(19) United States
(12) Patent Application Publication
(10) Pub. No.: US 2017/0046990 A1
(43) Pub. Date: Feb. 16, 2017

(54) DOOR HANDLE DISPLAY MEMBER

(71) Applicant: Display Technologies, LLC, Lake Success, NY (US)

(72) Inventors: Stephen Cummings, East Rockaway, NY (US); Marty Illers, Yonkers, NY (US)

(21) Appl. No.: 15/236,885

(22) Filed: Aug. 15, 2016

Related U.S. Application Data
(60) Provisional application No. 62/204,598, filed on Aug. 13, 2015.

(51) Int. Cl. G09F 23/00; E05B 1/00; G09F 7/18; G09F 23/06; G09F 7/10

(52) U.S. Cl. CPC G09F 23/00; G09F 23/06; G09F 7/10; G09F 7/18; E05B 1/0084; G09F 2007/1847; G09F 2007/1856

(57) ABSTRACT

A door handle display member including a first bracket, a second bracket, and a graphics panel. The first bracket is configured to releasably engage a door handle, such that the first bracket at least partially surrounds the door handle. The second bracket is configured to engage the first bracket. The graphics panel is configured to releasably engage the second bracket.

### CROSS-REFERENCE TO RELATED APPLICATION

The present application claims priority to, and the benefit of, U.S. Provisional Patent Application Ser. No. 62/204,598 filed on Aug. 13, 2015, the entire contents of which being herein incorporated by reference in its entirety.

### BACKGROUND

The present disclosure relates to display members that are configured to be engaged with a door handle. More particularly, the present disclosure relates to door handle display members that are engageable with a handle of a door (e.g., a refrigerator door) in a retail environment, for example, and which is configured to display product information.

### SUMMARY

The present disclosure relates to a door handle display member including a first bracket, a second bracket, and a graphics panel. The first bracket is configured to releasably engage a door handle, such that the first bracket at least partially surrounds the door handle. The second bracket is configured to engage the first bracket. The graphics panel is configured to releasably engage the second bracket.

In disclosed embodiments, the second bracket includes at least one channel associated therewith, and the graphics panel is configured to engage the at least one channel.

It is also disclosed that the graphics panel may be flat or curved.

It is further disclosed that the door handle display member may include a curved front panel configured to releasably engage the second bracket. A curved graphics panel is configured to releasably engage to the curved front panel.

In disclosed embodiments, the first bracket may include a C-shaped cross-section along an entirety of its length.

It is also disclosed that the second bracket is configured to engage the first bracket using hook and loop fasteners (e.g., VELCRO®). In embodiments, a first part of the hook and loop fastener is disposed on the first bracket, and a second part of the hook and loop fastener is disposed on the second bracket.

It is further disclosed that the second bracket includes two U-shaped sections configured to individually engage the first bracket.

The present disclosure also relates to a method of engaging a door handle display member with a door handle. The method includes engaging a first bracket with a door handle, engaging a second bracket with the first bracket after engaging the first bracket with the door handle, and inserting a graphics panel into a channel in the second bracket.

In embodiments of the method, engaging the second bracket with the first bracket includes using a hook and loop fastener.

It is further disclosed that engaging the first bracket with the door handle includes engaging at least a proximal wall and a distal wall of the first bracket with the door handle. Further embodiments of the method include engaging a distal wall of the second bracket with the distal wall of the first bracket.

### BRIEF DESCRIPTION OF DRAWINGS

Embodiments of the present disclosure are described hereinbelow with reference to the drawings wherein:

FIG. 1 is a perspective view of a first bracket of a door handle display member in accordance with an embodiment of the present disclosure;

FIG. 2 is a perspective view of the first bracket of the door handle display member of FIG. 1 engaged with a door handle;

FIG. 3 is a perspective view of a second bracket of the door handle display member of FIGS. 1 and 2;

FIG. 3A is a top view of the second bracket of the door handle display member of FIGS. 1-3;

FIG. 4 is a perspective view of the second bracket engaged with the first bracket of the door handle display member of FIGS. 1-3A, while the first bracket is engaged with a door handle;

FIG. 5 is a perspective view of a curved front panel and a graphic panel engaging the first and second brackets of the door handle display member of FIGS. 1-4;

FIG. 6 is a front view of the door handle display member of FIGS. 1-5 engaged with a door handle;

FIG. 7 is a perspective view of the door handle display member of FIGS. 1-6 engaged with a door handle;

FIG. 8 is a perspective view of the door handle display member of FIGS. 1-7 engaged with a door handle of a refrigerated case displaying a plurality of beverage containers;

FIG. 9 is a perspective view of a first bracket of a door handle display member in accordance with an embodiment of the present disclosure;

FIG. 10 is a perspective view of the first bracket of the door handle display member of FIG. 9 engaged with a door handle;

FIG. 11 is a perspective view of a second bracket of the door handle display member of FIGS. 9 and 10;

FIG. 11A is a top view of the second bracket of the door handle display member of FIGS. 9-11;

FIG. 12 is a perspective view of the second bracket of the door handle display member of FIGS. 9-11A engaged with the first bracket of FIGS. 9 and 10, which is engaged with a door handle;

FIG. 13 is a perspective view of a graphic panel engaging the first and second brackets of the door handle display member of FIGS. 9-12;

FIG. 14 is a front view of the door handle display member of FIGS. 9-13 engaged with a door handle;

FIG. 15 is a perspective view of the door handle display member of FIGS. 9-14 engaged with a door handle;

FIG. 16 is a perspective view of the door handle display member of FIGS. 9-15 engaged with a door handle of a refrigerated case displaying a plurality of beverage containers;

FIG. 17 is a perspective view of a door handle display member in accordance with an embodiment of the present disclosure; and

FIG. 18 is an assembly view of the door handle display member of FIG. 17.

### DETAILED DESCRIPTION

Embodiments of the presently disclosed door handle display members are described in detail with reference to the drawings wherein like numerals designate identical or corresponding elements in each of the several views. In the descriptions that follow, the term “proximal,” as is traditional, will refer to the portions of the door handle display members that are closer to the user (e.g., consumer), while the term “distal” will refer to the portions that are farther from the user.

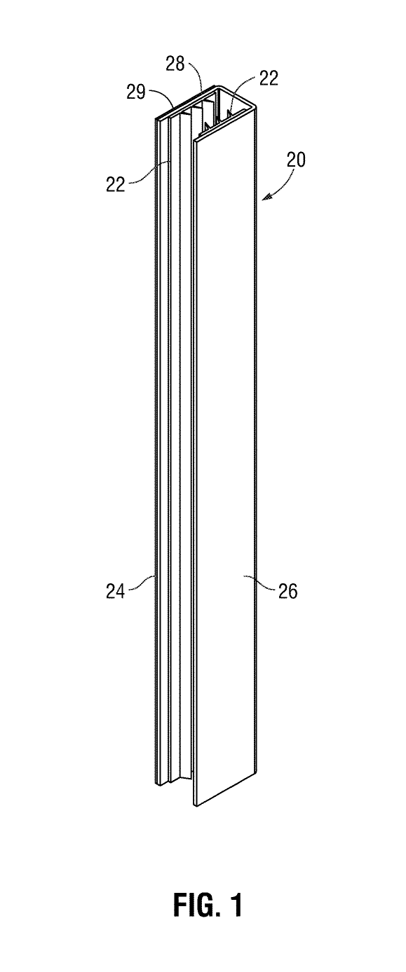

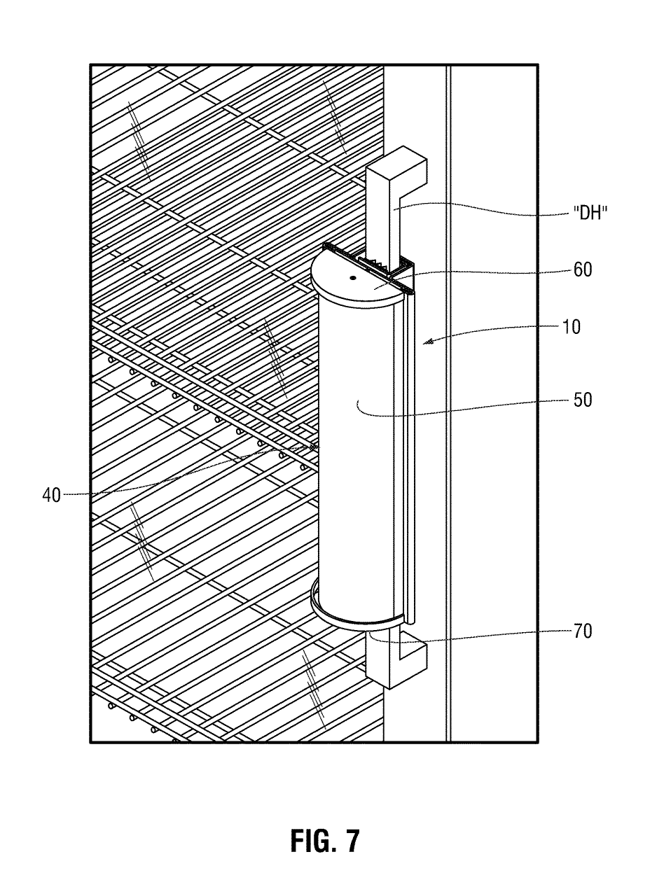

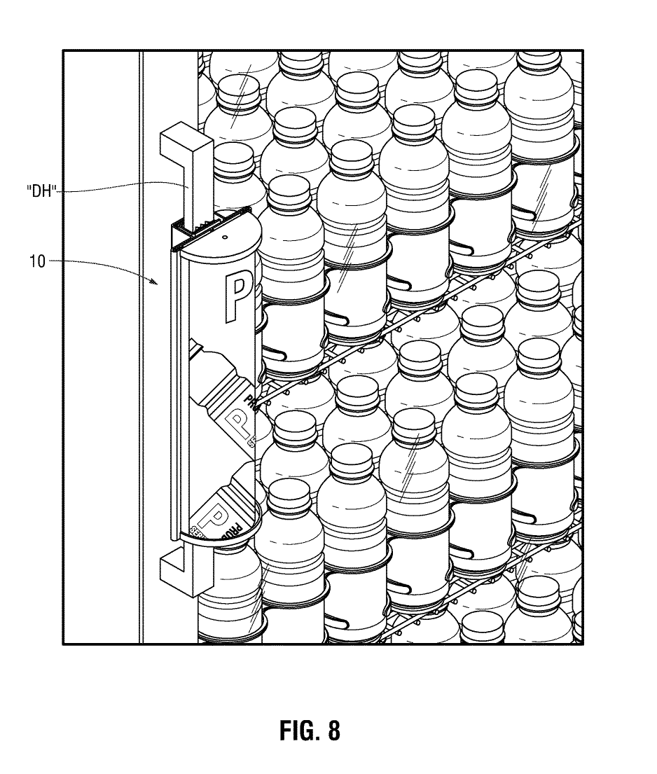

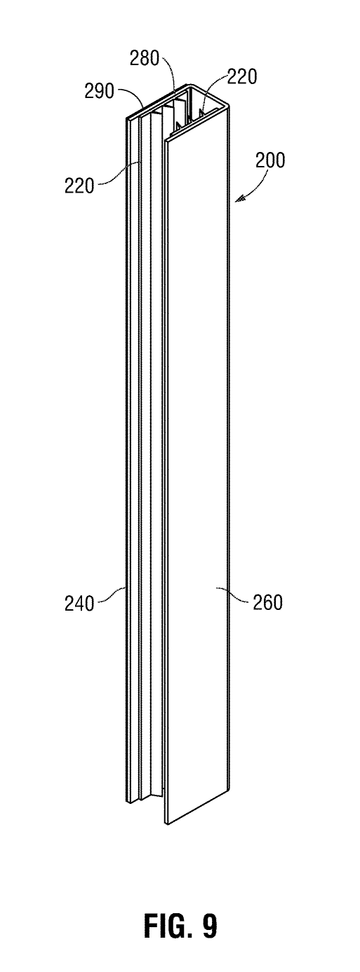

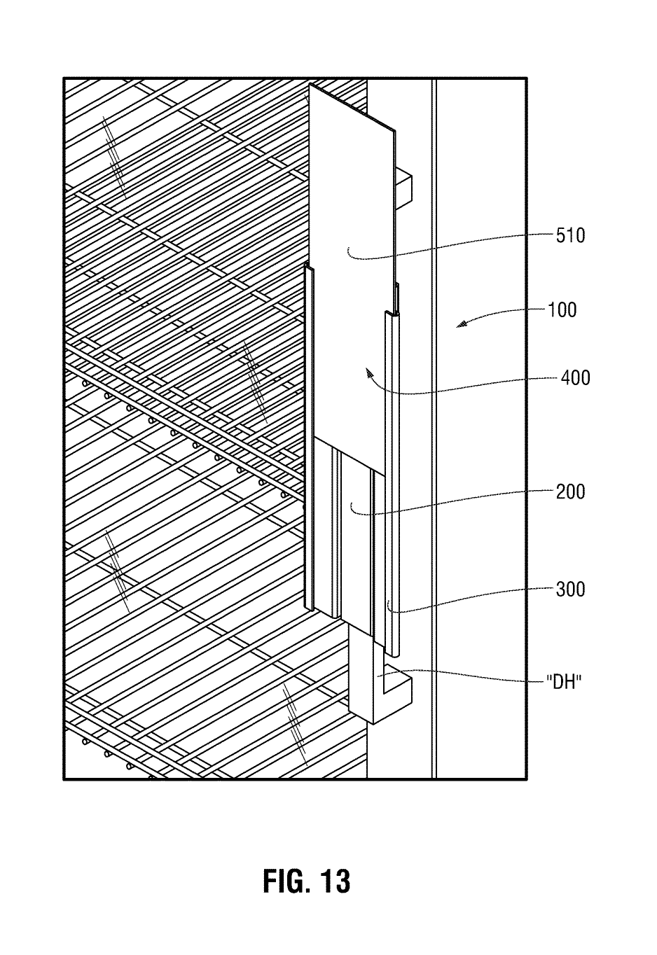

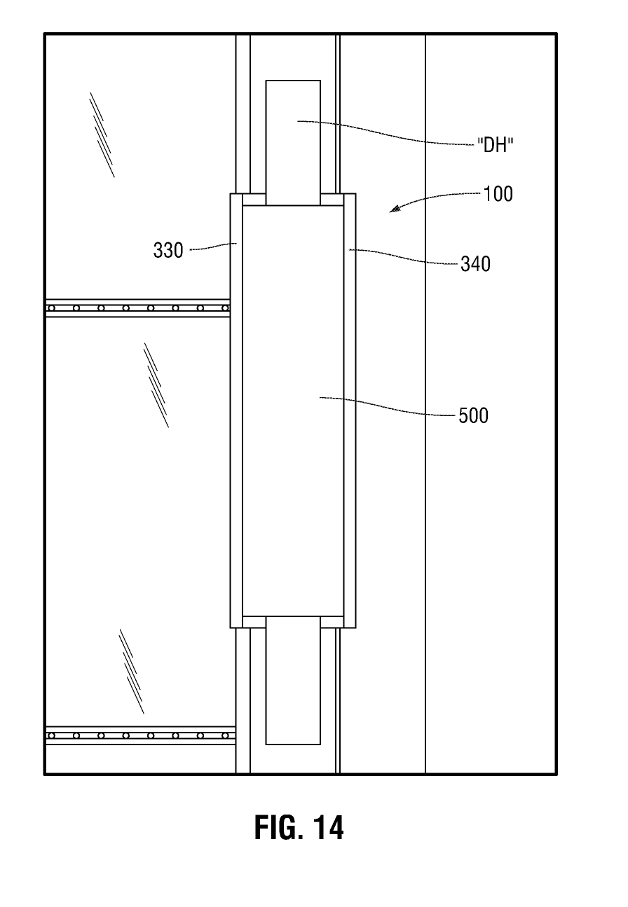

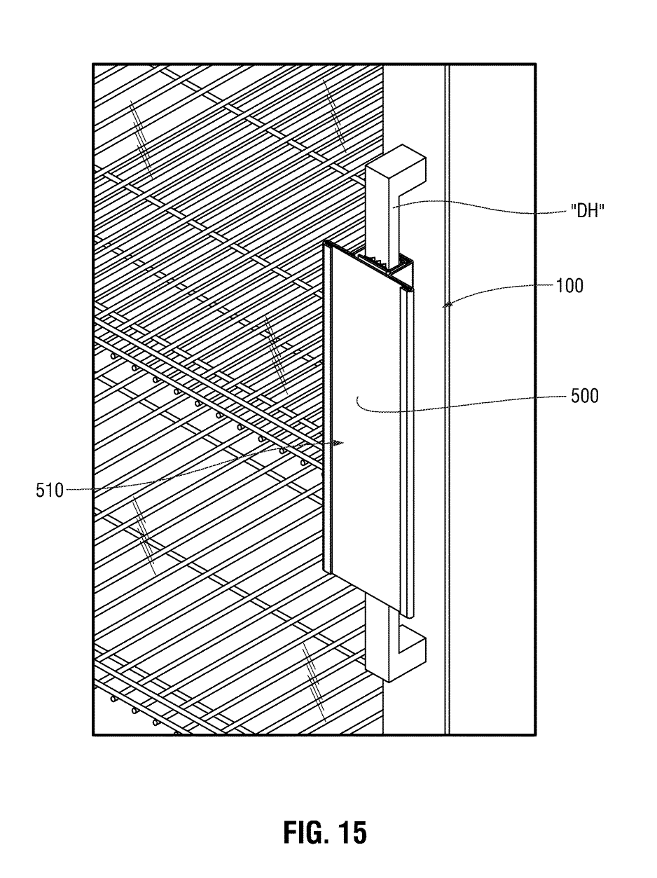

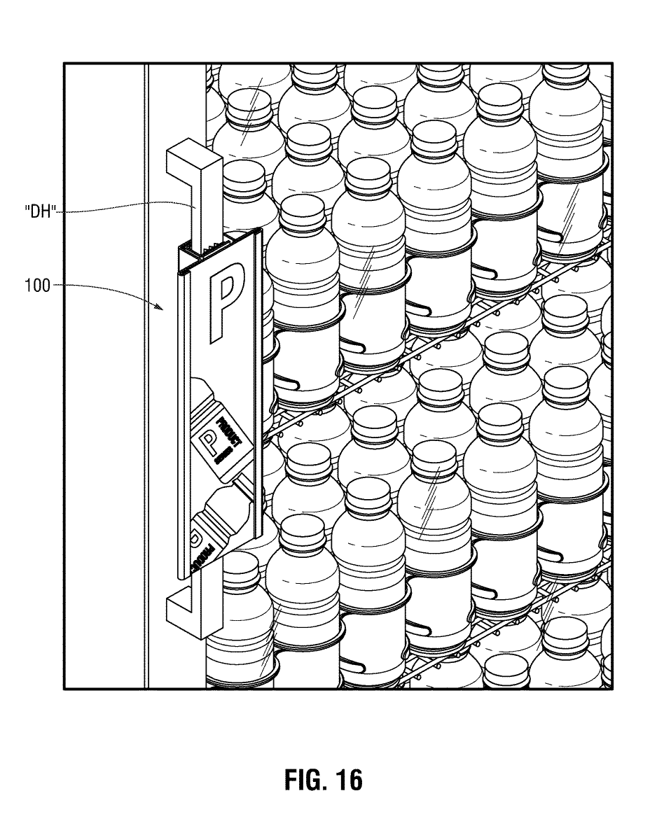

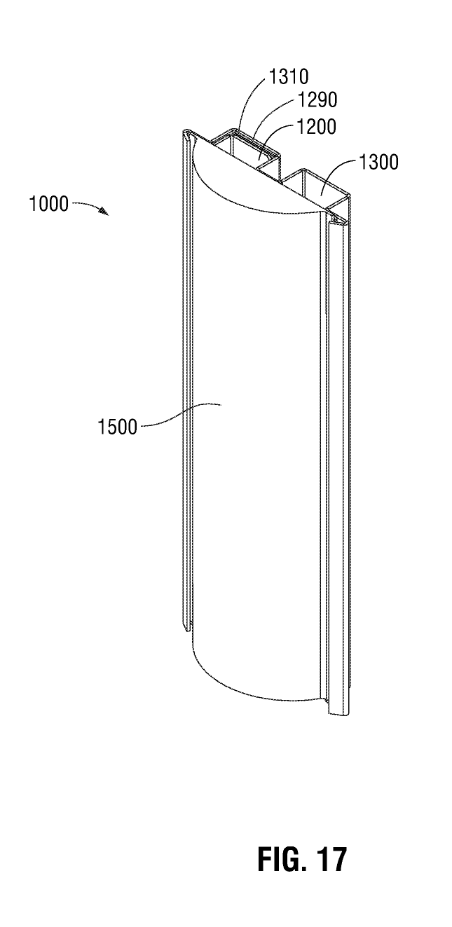

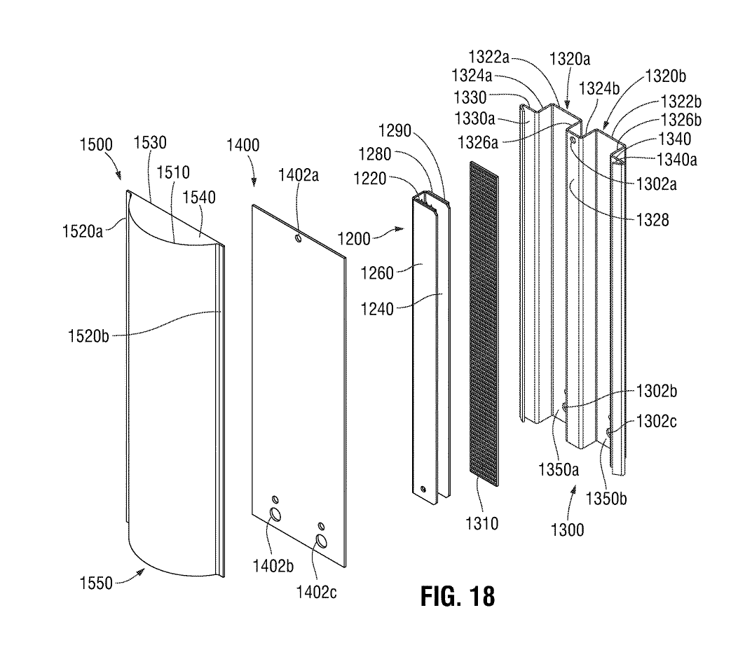

With reference to the accompanying figures, a first embodiment of a door handle display member 10 is illustrated in FIGS. 1-8, a second embodiment of a door handle display member 100 is illustrated in FIGS. 9-16, and a third embodiment of a door handle display member 1000 is illustrated in FIGS. 17-18. With initial reference to the embodiment illustrated in FIGS. 1-8, door handle display member 10 includes a first bracket 20, a second bracket 30, a curved front panel 40, an information display portion or graphics panel 50, a top cap 60, and a bottom cap 70.

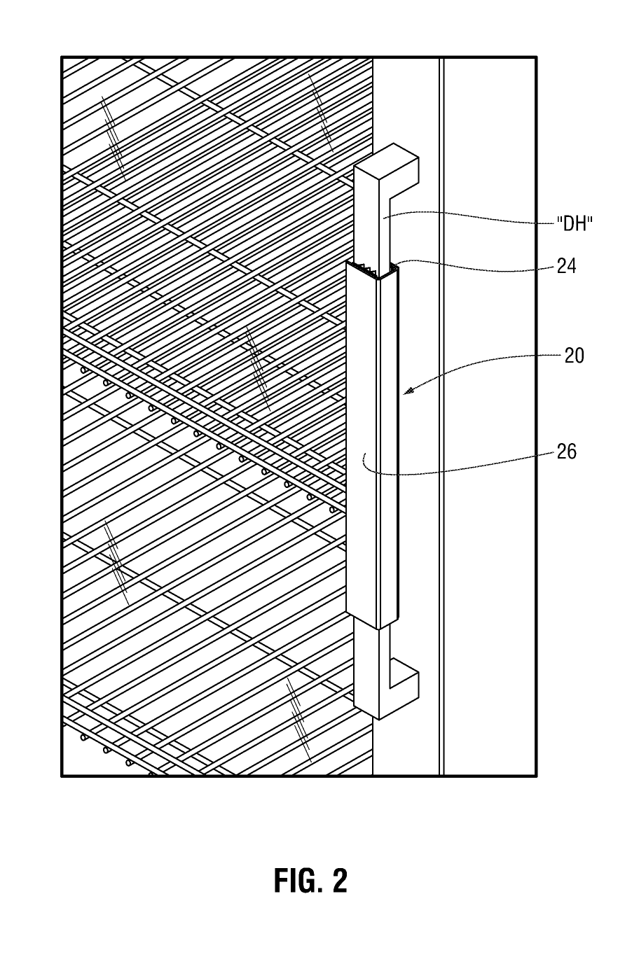

With particular reference to FIG. 1, the first bracket 20 is elongated, includes a generally C-shaped cross-section, and is configured to engage a door handle “DH” (FIG. 2). At least one inner portion 22 of the first bracket 20 includes a high-friction surface (e.g., a coating or texture) or fins (e.g., plastic fins) for facilitating secure engagement with the door handle “DH.” Moreover, the first bracket 20 is configured to slide sideways or laterally onto the door handle “DH” and effectively sandwiches the door handle “DH” between sidewalls 24, 26 of the first bracket 20. It is envisioned that the sidewalls 24, 26 can flex with respect to each other to help the first bracket 20 slide onto the door handle “DH.” Further, the first bracket 20 is sized and dimensioned to snuggly fit on a door handle “DH” and may be suitably sized for engagement with any type of door handle. It is contemplated that bracket 20 is configured such that an opening between sidewalls 24, 26 may slidably engage the door handle “DH” such sidewall 26 faces proximally (FIG. 2) or faces distally (not shown).

Additionally, an outer portion 28 of the first bracket 20 is located distally of the sidewall 24 and includes a first part of a fastener 29 (e.g., a hook-and-loop-type fastener, such as VELCRO® or low profile VELCRO®). The first part of the fastener 29 is configured to engage a second part of the fastener 31 (e.g., a hook-and-loop-type fastener, such as VELCRO® or low profile VELCRO) disposed on a portion of the second bracket 30, as described in further detail below.

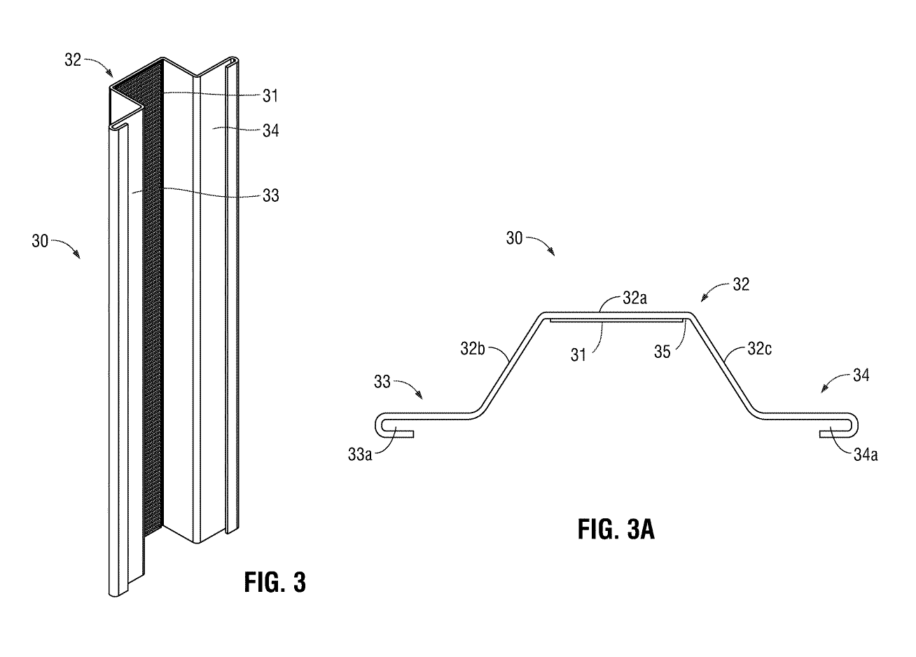

With particular reference to FIGS. 3 and 3A, the second bracket 30 is elongated, includes a generally C-shaped section 32, and first and second wings 33, 34, respectively, extending from the C-shaped section 32. The C-shaped section 32 includes a base 32a, a first leg 32b, and a second leg 32c. The first and second legs 32b, 32c extend from the base 32a at non-perpendicular angles or obtuse angles. Additionally, the base 32a is generally parallel to the first and second wings 33, 34.

The second bracket 30 is configured to mechanically engage the first bracket 20. More particularly, the second part of the fastener 31 is disposed on an inner surface 35 of the base 32a and is configured to engage (e.g., releasably engage) the first part of the fastener 29 on the outer portion 28 of the first bracket 20.

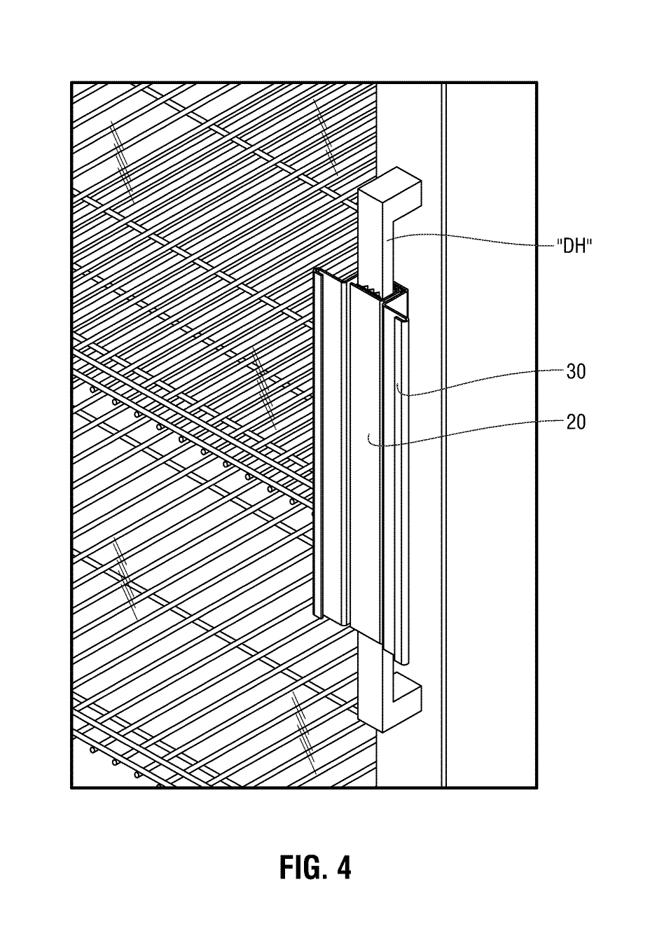

To engage the second bracket 30 with the first bracket 20, the second bracket 30 is positioned adjacent the first bracket 20 such that the inner surface 35 of the base 32a is adjacent the outer portion 28 of the sidewall 24 of the first bracket 20. Next, the second part of the fastener 31 is moved into contact with the first part of the fastener 29 and is pressed thereagainst, resulting in a secure connection therebetween (see FIG. 4).

With particular reference to FIG. 3A, each of the first wing 33 and the second wing 34 of the second bracket 30 defines respective channels 33a, 34a. Channels 33a, 34a are generally C-shaped or U-shaped and are configured to accept the curved front panel 40 therein. Further, the channels 33a, 34a are open at the top portions (to receive the curved front panel 40), and are closed at the bottom portions (to prevent the curved front panel 40 from falling out of engagement with the second bracket 30).

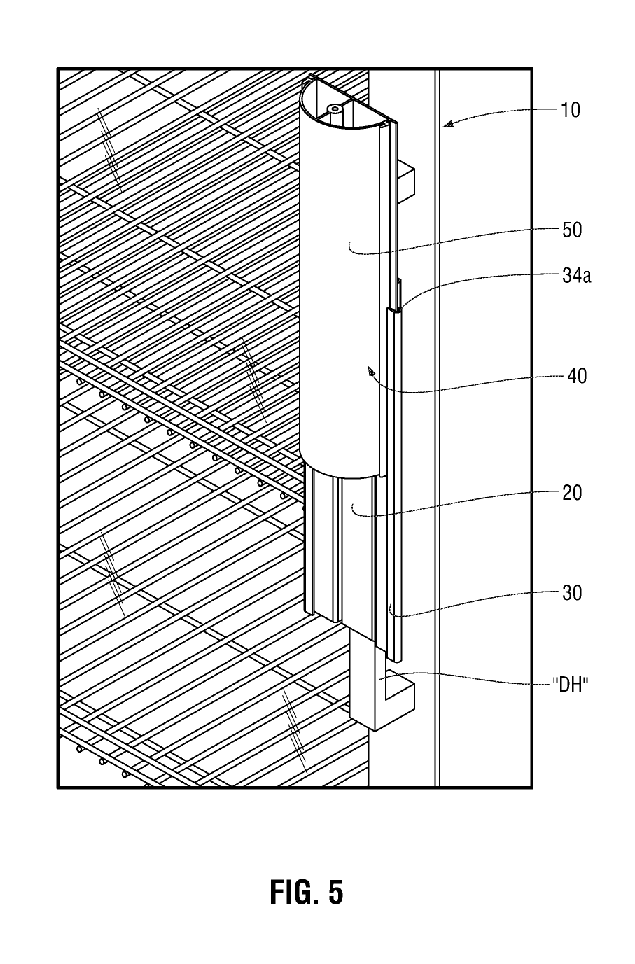

The curved front panel 40 is curved along its length and is configured to slide into the channels 33a, 34a from thereabove (see FIG. 5). The curved front panel 40 also includes a proximal lens (e.g., transparent or translucent) and a cavity defined between the proximal lens and a body of the curved front panel 40. The graphics panel 50 may be slidable into the cavity (e.g., from the top, bottom or sides of the cavity) such that product information displayed on the graphics panel 50, for example, is visible to a customer through the proximal lens.

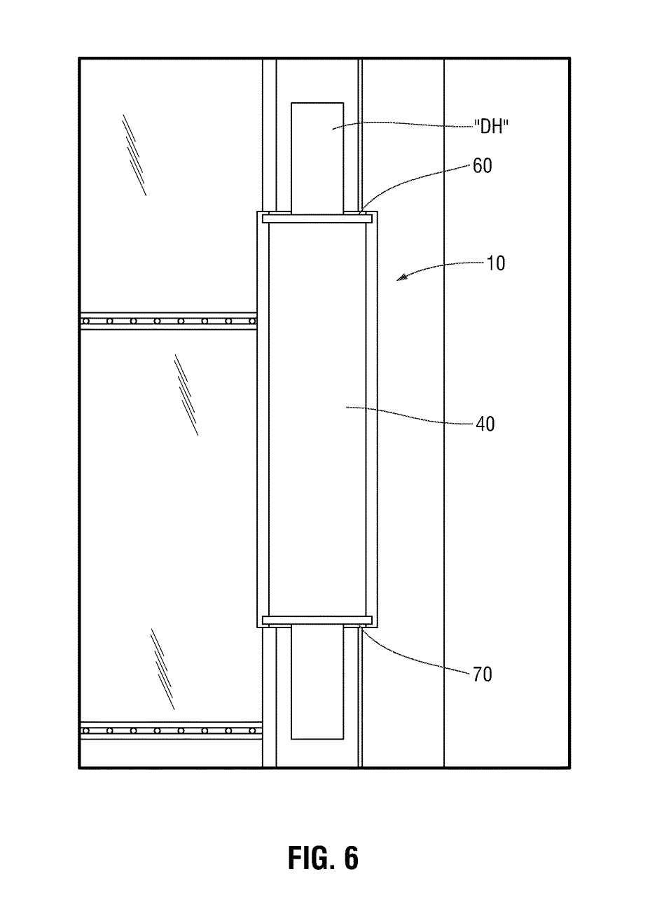

The top cap 60 and the bottom cap 70 (FIG. 6) are attachable to the curved front panel 40, e.g., via a screw, other mechanical fasteners, or adhesives. It is envisioned that the top cap 60 and the bottom cap 70 help prevent unwanted removal of the graphics panel 50 and help facilitate removal of the graphics panel 50 from the cavity for updating or replacement, for example.

Referring now to the embodiment illustrated in FIGS. 9-16, door handle display member 100 includes a first bracket 200, a second bracket 300, and an information display portion or graphics panel 500.

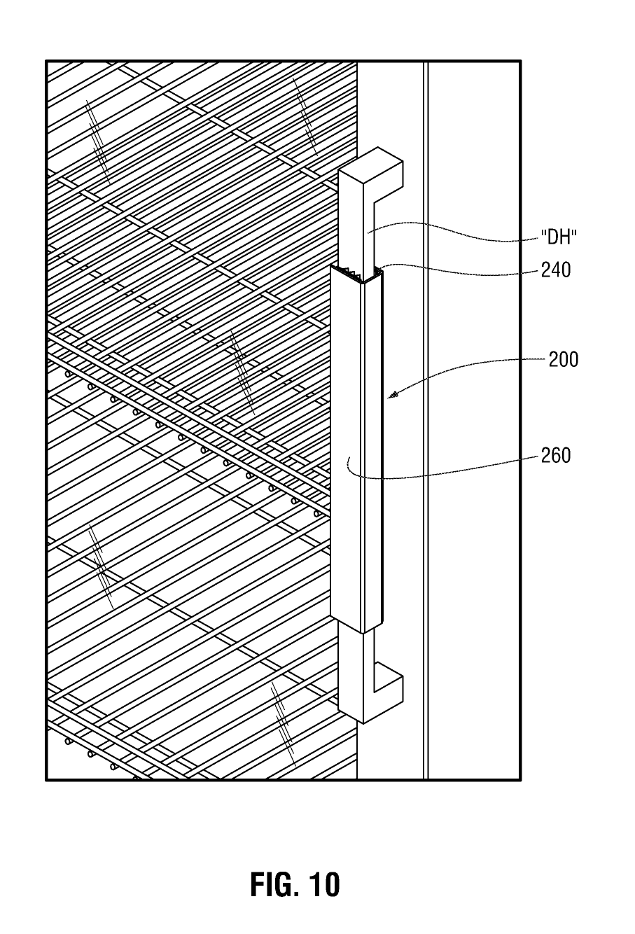

With particular reference to FIG. 9, the first bracket 200 is elongated, includes a generally C-shaped cross-section, and is configured to engage a door handle “DH” (FIG. 10). At least one inner portion 220 of the first bracket 200 includes a high-friction surface (e.g., a coating or texture) or fins (e.g., plastic fins) for facilitating secure engagement with the door handle “DH.” Moreover, the first bracket 200 is configured to slide laterally onto the door handle “DH” and effectively sandwiches the door handle “DH” between sidewalls 240, 260 of the first bracket 200. It is envisioned that the sidewalls 240, 260 can flex with respect to each other to help the first bracket 200 slide onto the door handle “DH.” Further, the first bracket 200 is sized and dimensioned to snuggly fit on a door handle “DH” and may be suitably sized for engagement with any type of door handle. It is contemplated that the first bracket 200 is configured such that an opening between sidewalls 240, 260 may slidably engage the door handle “DH” such that sidewall 260 faces proximally (FIG. 10) or faces distally (not shown).

Additionally, an outer portion 280 of the first bracket 200 is located distally of the sidewall 240 and includes a first part of a fastener 290 (e.g., a hook-and-loop-type fastener, such as VELCRO® or low profile VELCRO®). The first part of the fastener 290 is configured to engage a second part of the fastener 310 (e.g., a hook-and-loop-type fastener, such as VELCRO® or low profile VELCRO®) disposed on a portion of the second bracket 300, as described in further detail below.

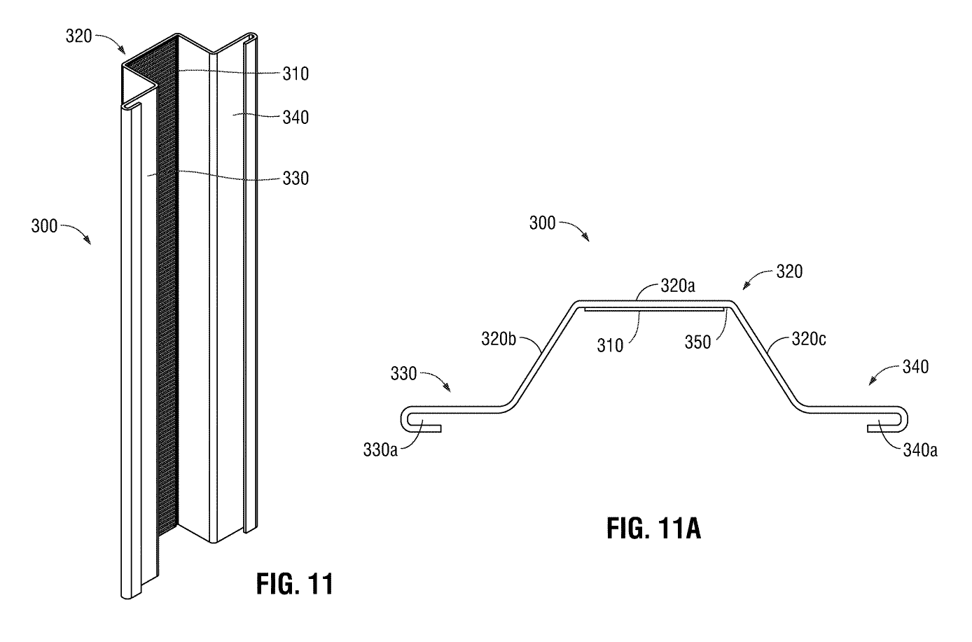

With particular reference to FIG. 11, the second bracket 300 is elongated, includes a generally C-shaped section 320, and first and second wings 330, 340, respectively, extending from the C-shaped section 320. The C-shaped section 320 includes a base 320a, a first leg 320b, and a second leg 320c. The first and second legs 320b, 320c extend from the base 320a at non-perpendicular angles or obtuse angles. Additionally, the base 320a is generally parallel to the first and second wings 330, 340.

The second bracket 300 is configured to mechanically engage the first bracket 200. More particularly, the second part of the fastener 310 is disposed on an inner surface 350 of the base 320a and is configured to engage (e.g., releasably engage) the first part of the fastener 290 on the outer portion 280 of the first bracket 200.

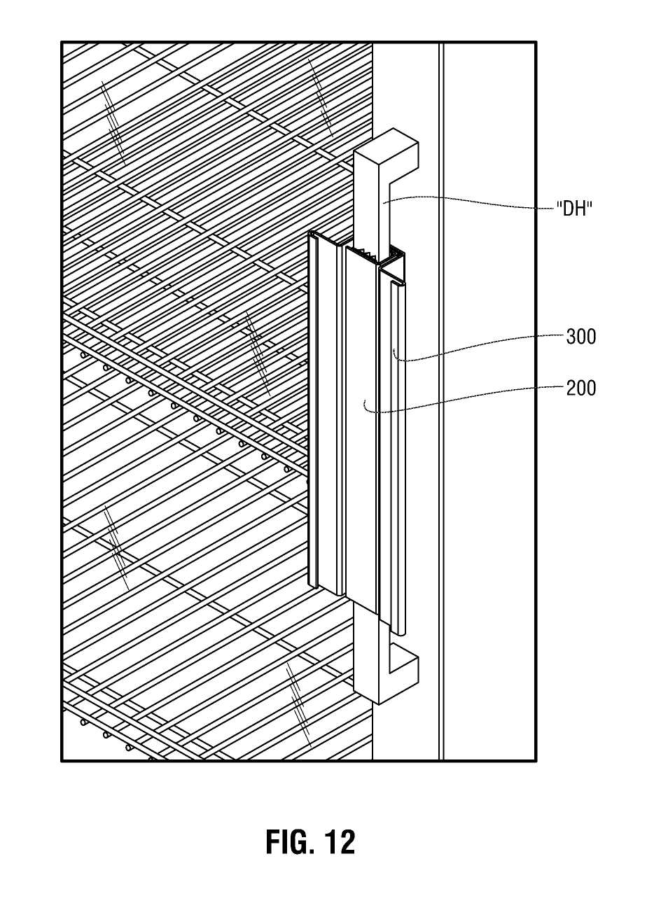

To engage the second bracket 300 with the first bracket 200, the second bracket 300 is positioned adjacent the first bracket 200 such that the inner surface 350 of the base 320a is adjacent the outer portion 280 of the sidewall 240 of the first bracket 200. Next, the second part of the fastener 310 is moved into contact with the first part of the fastener 290 and is pressed thereagainst, resulting in a secure connection therebetween (see FIG. 12).

With particular reference to FIG. 11A, each of the first wing 330 and the second wing 340 of the second bracket 300 includes respective channels 330a, 340a thereon. Channels 330a, 340a are generally C-shaped or U-shaped and are configured to accept the graphics panel 500 and a flat cover 510 (e.g., made from a transparent or translucent material). Further, the channels 330a, 340a are open at the top portions (to receive the graphics panel 500 and the flat cover 510), and are closed at the bottom portions (to prevent the graphics panel 500 and the flat cover 510 from falling out of engagement with the second bracket 300). The graphics panel 500 is slidable between the channels 330a, 340a such that product information on the graphics panel 500, for example, is visible to a customer through the flat cover 510.

As can be appreciated, the same first and second brackets are usable with the first embodiment of the door handle display member 10 (illustrated in FIGS. 1-8) and the second embodiment of the door handle display member 100 (illustrated in FIGS. 9-16), thus increasing the utility of the brackets.

Referring now to the embodiment illustrated in FIGS. 17-18, door handle display member 1000 includes a first bracket 1200, a second bracket 1300, a rectangular support 1400 (FIG. 18), and an information display portion or graphics panel 1500.

With particular reference to FIG. 18, the first bracket 1200 is elongated, includes a generally C-shaped cross-section, and is configured to engage a door handle “DH” (similar to the door handles “DH” of FIG. 2, for example). At least one inner portion 1220 of the first bracket 1200 includes a high-friction surface (e.g., a coating, texture, or a plurality of fins (such as plastic fins) protruding therefrom) for facilitating secure engagement with the door handle “DH.” Moreover, the first bracket 1200 is configured to slide laterally onto the door handle “DH” and effectively sandwiches the door handle “DH” between sidewalls 1240, 1260 of the first bracket 1200. It is envisioned that the sidewalls 1240, 1260 can flex with respect to each other to help the first bracket 1200 slide onto the door handle “DH.” Further, the first bracket 1200 is sized and dimensioned to snuggly fit on a door handle “DH” and may be suitably sized for engagement with any type of door handle. It is contemplated that the first bracket 1200 is configured such that an opening between sidewalls 1240, 1260 may slidably engage the door handle “DH” such that sidewall 1260 faces proximally (FIG. 18) or faces distally (not shown).

Additionally, an outer portion 1280 of the first bracket 1200 is located distally of the sidewall 1240 and includes a first part of a fastener 1290 (e.g., a hook-and-loop-type fastener, such as VELCRO® or low profile VELCRO®). The first part of the fastener 1290 is configured to engage a second part of the fastener 1310 (e.g., a hook-and-loop-type fastener, such as VELCRO® or low profile VELCRO®) disposed on a portion of the second bracket 1300, as described in further detail below.

With particular reference to FIG. 18, the second bracket 1300 is elongated, includes two generally U-shaped sections 1320a, 1320b, and first and second wings 1330, 1340, respectively, each extending from one U-shaped section 1320a, 1320b. Each U-shaped section 1320a, 1320b includes a respective base 1322a, 1322b, first leg 1324a, 1324b, and second leg 1326a, 1326b. Further, a connection portion 1328 interconnects second leg 1326a of U-shaped section 1320a and first leg 1324a of U-shaped section 1320b, and is generally parallel to bases 1322a and 1322b. The first legs 1324a, 1324b and second legs 1326a, 1326b extend generally perpendicularly from their respective bases 1322a, 1322b.

The second bracket 1300 is configured to mechanically engage the first bracket 1200. More particularly, the second part of the fastener 1310 is disposed on or is engageable with a first inner surface 1350a or a second inner surface 1350b of the second bracket 1300 and is configured to engage (e.g., releasably engage) the first part of the fastener 1290 on the outer portion 1280 of the first bracket 1200.

To engage the second bracket 1300 with the first bracket 1200, the second bracket 1300 is positioned adjacent the first bracket 1200 such that inner surface 1350a or 1350b of the second bracket 1300 is adjacent the outer portion 1280 of the sidewall 1240 of the first bracket 1200. Next, the second part of the fastener 1310 is moved into contact with the first part of the fastener 1290 and is pressed thereagainst, resulting in a secure connection therebetween (see FIG. 17). Additionally, while the accompanying figures show the second part of the fastener 1310 engaged with inner portion 1350a, the present disclosure also includes the second part of the fastener 1310 being engaged with inner portion 1350b.

The inclusion of two U-shaped sections 1320a, 1320b enables the door handle display member 1000 to be installed in a position that is off-set from centered with respect to the door handle “DH.” Thus, one door handle display member 1000 can be installed on a right-hand door, and one door handle display member 1000 can be installed on a left-hand door. In each type of installation, the door handle display member 1000 is offset toward the hinge of the door. This enables stores to stock a single type of door handle display member 1000 to be used for right- and left-hand doors, and also enables two door handle display members 1000 to be installed on adjacent door handles “DH” with interfering with each other.

Each of the first wing 1330 and the second wing 1340 of the second bracket 1300 includes respective channels 1330a, 1340a thereon. Channels 1330a, 1340a are generally C-shaped, V-shaped, J-shaped or U-shaped and are configured to accept the rectangular support 1400 and graphics panel 1500. Further, the channels 1330a, 1340a are open at the top portions (to receive the graphics panel 1500), and are closed at the bottom portions (to prevent the graphics panel 1500 from falling out of engagement with the second bracket 1300).

The rectangular support 1400 is positioned between and/or at least partially within channels 1330a, 1340a, and may be secured to second bracket 1300 (e.g., with fasteners). It is envisioned that each fastener (not shown) extends through a hole 1402a, 1402b, 1402c (e.g., a tapped hole) in rectangular support 1400 and a corresponding hole 1302a, 1302b, 1302c (e.g., a tapped hole) to secure the rectangular support 1400 to the second bracket 1300.

The graphics panel 1500 is slidable between the channels 1330a, 1340a such that product information on or within the graphics panel 1500, for example, is visible to a customer. It is envisioned that graphics panel 1500 includes a curved front section 1510, a first lateral arm 1520a for engaging channel 1330a, a second lateral arm 1520b for engaging channel 1330b, and a back section 1530 for contacting rectangular support 1400. Graphics panel 1500 may also include a top section 1540, and/or a bottom section 1550. Thus, graphics panel 1500 defines a cavity which may include a graphics card therein. Alternatively or additionally, a graphics card may be secured (e.g., adhered) to the rectangular support 1400.

Further, graphics panel 1500 may include a light source (not explicitly shown) disposed between the curved front section 1510 and the back section 1530, for illuminating portions of door handle display member 1000, such that door handle display member 1000 is more visible or more desirable to a user, for instance.

As can be appreciated, the graphics panel 50, 500, 1500 which made be made from plastic or another suitable material or graphics card, can be tailored to any specific or desirable need. For example, graphics panel 50, 500, 1500 or graphics card can display advertising information, product information, price information, etc., and is easily replaceable to depict a different product, for example, by sliding graphics panel 50, 500, 1500 upward with respect to the second bracket 30, 300, 1300 respectively. The graphics panel 50, 500, 1500 on a refrigerator door handle “DH,” for example, provides an additional area of advertisement for a retailer, which may lead to greater product sales. Additionally, the disclosed door handle display members 10, 100, 1000 may also provide an insulating layer between the cold door handle “DH” and a customer's hand.

The present disclosure also includes methods of displaying product information using the door handle display members 10, 100, 1000 and methods of engaging door handle display members 10, 100, 1000 with a door handle “DH.” Such methods include engaging the first bracket 20, 200, 1200 with a door handle “DH,” engaging the second bracket 30, 300, 1300 with the first bracket 20, 200, 1200, and inserting the graphics panels 50, 500, 1500 onto the respective second bracket 30, 300, 1300.

While embodiments of the disclosure have been shown in the figures, it is not intended that the disclosure be limited thereto, as it is intended that the disclosure be as broad in scope as the art will allow and that the specification be read likewise. Therefore, the above description should not be construed as limiting, but merely as exemplifications of various embodiments. Those skilled in the art will envision other modifications within the scope and spirit of the claims appended hereto.

1. A door handle display member, comprising:
a first bracket configured to releasably engage a door handle, such that the first bracket at least partially surrounds the door handle;
a second bracket configured to engage the first bracket; and
a graphics panel configured to releasably engage the second bracket.

2. The door handle display member according to claim 1, wherein the second bracket includes at least one channel associated therewith, and wherein the graphics panel is configured to engage the at least one channel.

3. The door handle display member according to claim 1, wherein the graphics panel is flat.

4. The door handle display member according to claim 1, further comprising a curved front panel configured to releasably engage the second bracket.

5. The door handle display member according to claim 4, wherein the graphics panel is curved, and wherein the graphics panel is configured to releasably engage to the curved front panel.

6. The door handle display member according to claim 1, wherein the first bracket includes a C-shaped cross-section.

7. The door handle display member according to claim 1, wherein the first bracket includes a C-shaped cross-section along an entirely of its length.

8. The door handle display member according to claim 1, wherein the second bracket is configured to engage the first bracket with a hook and loop fastener.

9. The door handle display member according to claim 8, wherein a first part of the hook and loop fastener is disposed on the first bracket, and wherein a second part of the hook and loop fastener is disposed on the second bracket.

10. The door handle display member according to claim 1, wherein the second bracket includes two U-shaped sections configured to individually engage the first bracket.

11. A method of engaging a door handle display member with a door handle, comprising:
engaging a first bracket with a door handle;
engaging a second bracket with the first bracket after engaging the first bracket with the door handle; and
inserting a graphics panel into a channel in the second bracket.

12. The method according to claim 11, wherein engaging the second bracket with the first bracket includes using a hook and loop fastener.

13. The method according to claim 11, wherein engaging the first bracket with the door handle includes engaging at least a proximal wall and a distal wall of the first bracket with the door handle.

14. The method according to claim 13, wherein engaging the second bracket with the first bracket includes engaging a distal wall of the second bracket with the distal wall of the first bracket.
